(19) United States
(12) Patent Application Publication
(10) Pub. No.: US 2021/0192001 A1
(43) Pub. Date: Jun. 24, 2021

(54) Social Media Content Ranking System and Method

(71) Applicants: Cornelius Brown, New Orleans, LA (US); Rondeara Brown, New Orleans, LA (US)

(72) Inventors: Cornelius Brown, New Orleans, LA (US); Rondeara Brown, New Orleans, LA (US)

(21) Appl. No.: 17/132,466

(22) Filed: Dec. 23, 2020

Related U.S. Application Data
(60) Provisional application No. 62/952,751, filed on Dec. 23, 2019.

(51) Int. Cl. G06F 16/9536; H04N 21/84; H04N 21/433; H04N 21/234; H04N 21/44; G06F 16/2457; G06F 16/435; G06F 16/438

(52) U.S. Cl. CPC G06F 16/9536; H04N 21/84; H04N 21/4334; H04N 21/234; H04W 88/02; G06F 16/24578; G06F 16/435; G06F 16/438; H04N 21/44

(57) ABSTRACT

A social media content ranking system includes at least one user device and at least one content creator device in wireless communication with a database. The database is configured to perform a method including receiving a media item from the content creator device via a wireless network, assigning one or more metadata tags to the media item, wherein each metadata tag includes a descriptor and a number value, generating a content ranking score based on the metadata tag number values, and transmitting the content ranking score to the user device when the user device accesses the media item. A presenter device can transmit videos reviewing various content to the user devices. The metadata tags can correspond to views, shares, positive votes, downloads, or other actions that indicate viewer engagement with particular content. In this way, users are assisted with selecting particular content and content creators can monitor user engagement.

### CROSS REFERENCE TO RELATED APPLICATIONS

This application claims the benefit of U.S. Provisional Application No. 62/952,751 filed on Dec. 23, 2019. The above identified patent application is herein incorporated by reference in its entirety to provide continuity of disclosure.

### BACKGROUND OF THE INVENTION

The present invention relates to social media and content creation sharing. More particularly, the present invention pertains to a system and method for ranking social media content, allowing a content creator to track user engagement with their content, while also assisting consumers with selecting particular entertainment content based on their individual preferences.

Many individuals utilize social media platforms to access entertainment content, including music, videos, and other media items. Modern content creators often upload their creations to multiple platforms and media outlets for consumers to download or otherwise access and enjoy. This allows content creators to reach great numbers of potential users and consumers of their content. However, with so many options and platforms available, it can be difficult for a consumer to determine the exact content they wish to access. Further, the content creator is often unable to gauge the interest in their content because of how many access points and platforms are available. Tracking user engagement would assist the content creator in adapting or changing content based on their particular viewership goals. Further, a system that ranks particular content based on various user engagement metrics would assist users and content creators alike.

In view of the above, it is submitted that the present invention substantially diverges in structural, functional, and design elements from the prior art and consequently it is clear that there is a need in the art for an improvement within the field of social media content ranking and distribution. In this regard the present invention substantially fulfills these needs.

### SUMMARY OF THE INVENTION

In view of the foregoing disadvantages inherent in the known types of social media content ranking mechanisms now present in the prior art, the present invention provides a social media content ranking system and method that assists users with selecting particular entertainment content and also provides metrics and insight to content creators regarding user engagement with their content.

In one embodiment, the social media content ranking system and method includes a user device having at least a display screen, an input control, and a wireless transceiver, and a content creator device having at least a display screen, an input control, and a wireless transceiver. The system further includes a database having a wireless transceiver, a processor, a non-transitory computer readable medium operatively connected to the processor, and a logic stored in the non-transitory computer readable medium that, when executed by the processor, causes the social media content ranking system to perform a method. The method includes receiving a media item from the content creator device via a wireless network, assigning one or more metadata tags to the media item, wherein each metadata tag includes a descriptor and a number value, generating a content ranking score based on the metadata tag number values, and transmitting the content ranking score to the user device when the user device accesses the media item via the database.

One object of the present invention is to provide a social media content ranking system and method that further includes one or more presenter devices, such that the presenter device transmits a video recording to the database regarding one or more content items, allowing the user device to receive and view the video recording.

Another object of the present invention is to provide a social media content ranking system and method wherein at least one of the metadata tags corresponds to a view count comprising a number of views a media item has received on one or more social media platforms within a particular time period.

A further object of the present invention is to provide a social media content ranking system and method wherein at least one of the metadata tags corresponds to a share count comprising a number of times a media item has been shared across one or more social media platforms within a particular time period.

Yet another object of the present invention is to provide a social media content ranking system and method wherein at least one of the metadata tags corresponds to a download count comprising a number of times a media item has been downloaded from one or more social media platforms within a particular time period.

Other objects, features, and advantages of the present invention will become apparent given the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the various components of an embodiment of the social media content ranking system and method.

FIG. 2 shows a diagram of the database and media item components of an embodiment of the social media content ranking system and method.

FIG. 3 shows a flowchart of method steps of an alternate embodiment of the social media content ranking system and method.

### DETAILED DESCRIPTION OF THE INVENTION

Reference is made herein to the attached drawings. Like reference numerals are used throughout the drawings to depict like or similar elements of the retractable floor cover. For the purposes of presenting a brief and clear description of the present invention, the preferred embodiment will be discussed as used for calculating a ranking score for a particular content item and transmitting the score to content creators and the system's other users. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a user device”, “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure. Further, the recitation of “memory” in the present application is intended to be a type of computer readable media.

As referred to herein, the terms “user device”, “content creator device”, “presenter device”, and “database” refer to various computing devices that are components of the present invention. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can include desktop computer systems, laptops, cell phones, tablets, networking devices, or any other device that incorporates hard-wired and/or program logic to implement the techniques and other features of the present disclosure.

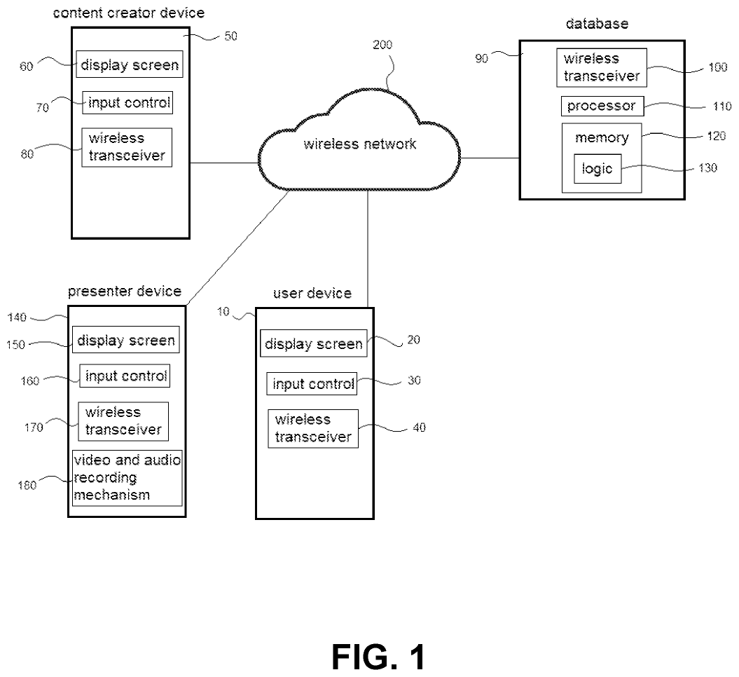

Referring now to FIG. 1, there is shown a diagram of the various components of an embodiment of the social media content ranking system and method. In general, the system includes a user device 10, a content creator device 50, a presenter device 140, and a database 90, all of which are in communication via a wireless network 200, such as the internet, for example. The user device 10 includes at least a display screen 20, an input control 30, and a wireless transceiver 40. The input control can include touchscreen controls, keyboard and mouse control, or any other suitable input mechanisms for computing devices. The system can operate with any number of user devices 10 such that a network of users can be created utilizing the system. The content creator device 50 also includes at least a display screen 60, an input control 70, and a wireless transceiver 100. Further, the presenter device 140 includes at least a display screen 150, a video and audio recording mechanism 180, an input control 160, and a wireless transceiver 170. The video and audio recording mechanism 180 allows the presenter device 140 to prepare a video review or other content in response to a media item received from the content creator device 50.

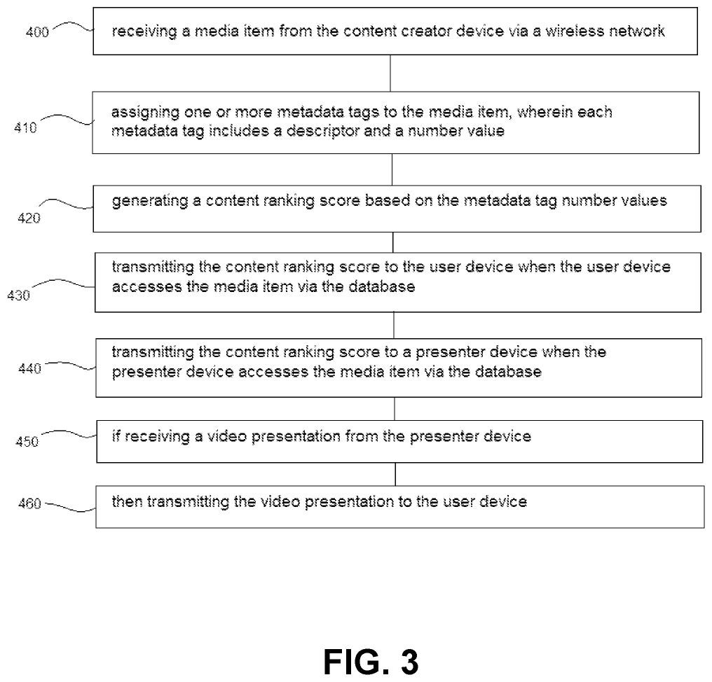

The database 90 of the system receives and transmits media items and other information wirelessly via the wireless network 200. The database 90 includes a wireless transceiver 100, a processor 110, a non-transitory computer readable medium operatively connected to the processor 110, such as a memory 120, and a logic 130 stored in the memory that, when executed by the processor 110, causes the social media content ranking system to perform a method, which is detailed in FIG. 3.

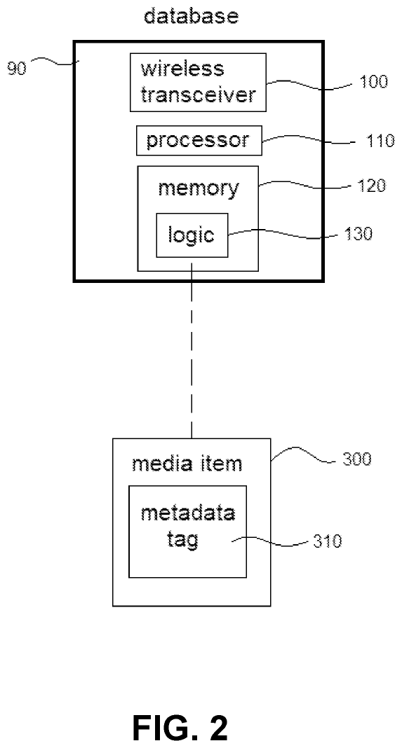

Referring now to FIG. 2, there is shown a diagram of the database and media item components of an embodiment of the social media content ranking system and method. The database 90 is configured to receive various media items 300 via the wireless network. The media items 300 can include, but are not limited to, audio recordings, video recordings, video and audio recordings, written works, visual works of art, etc. The media items 300 can be received directly from content creator devices, or can be received from any other source via the wireless network connection, such as various content hosting websites or social media websites. The database 90 includes logic 130 that interacts with a metadata tag 310 that defines various properties of the media item 300. The metadata tag 310 can be assigned from the source of the media item 300, or it can be assigned by the database 90 after it receives the media item 300 once additional information is calculated or received.

The metadata tag 310 includes at least one descriptor identifying its type and is assigned a number value via the logic 130. For example, the metadata tag 310 may corresponds to a view count comprising a number of views a media item has received on one or more social media platforms within a particular time period. Also, the metadata tag 310 may correspond to a share count comprising a number of times a media item has been shared across one or more social media platforms within a particular time period. Further, the metadata tag 310 may correspond to a download count comprising a number of times a media item has been downloaded from one or more social media platforms within a particular time period. As another example, the metadata tag may correspond to a positive vote count comprising a number of times a media item has been awarded a positive vote from one or more social media platforms within a particular time period. In this way, the metadata tag 310 helps to qualitatively analyze a media item 300. The metadata tag 310 thus provides the logic 90 with data to utilize when determining an overall ranking score for the media item.

Referring now to FIG. 3, there is shown a flowchart of method steps of an alternate embodiment of the social media content ranking system and method. First, the method includes receiving 400, at the database, a media item from a content creator device via a wireless network. The media item can be received through any suitable channels including but not limited to social media platforms, content hosting platforms, or the like. The method then includes assigning 410 one or more metadata tags to the media item, wherein each metadata tag includes a descriptor and a number value. The method then includes generating 420 a content ranking score based on the metadata tag number values. The generating of the score includes a comparison between number values across particular categories of metadata tags. For example, the content ranking score can include a calculation of the most viewed media item across multiple social media platforms, by comparing the number values assigned to the metadata tags for media items in that category. The content ranking score can be more general and factor in overall user engagement as determined by comparing data across all metadata tags.

Once a content ranking score is generated, the system transmits 430 the content ranking score to the user device when the user device accesses the media item via the database. In some embodiments, the user device 430 can access or receive the media item itself via a software application, website, or similar mechanism. In some embodiments, the method also includes transmitting 440 the content ranking score to the to the presenter device. This allows the presenter to create their own content in the form of a media review, based on the media item and the content ranking score generated by the system. The database receives 450 the recorded presentation from the presenter device, and transmits 460 the presentation to the user device. In this way, the system provides users with ranked scores and video reviews, which assists the user with determining which content they wish to access. Further, the content creator can utilize the content ranking score to gauge user engagement with their content, allowing to fine tune or adjust their future content accordingly in an attempt to reach a specific audience or a broader audience.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A social media content ranking system comprising:
a user device having at least a display screen, an input control, and a wireless transceiver;
a content creator device having at least a display screen, an input control, and a wireless transceiver;
a database comprising a wireless transceiver, a processor, a non-transitory computer readable medium operatively connected to the processor, and a logic stored in the non-transitory computer readable medium that, when executed by the processor, causes the social media content ranking system to perform a method, the method comprising:
receiving a media item from the content creator device via a wireless network;
assigning one or more metadata tags to the media item, wherein each metadata tag includes a descriptor and a number value;
generating a content ranking score based on the metadata tag number values;
transmitting the content ranking score to the user device when the user device accesses the media item via the database.

2) The social media content ranking system of claim 1, wherein the media item comprises an audio recording, a video recording, or an audio and video recording.

3) The social media content ranking system of claim 1, further comprising a presenter device having at least a display screen, a video and audio recording mechanism, an input control, and a wireless transceiver.

4) The social media content ranking system of claim 3, wherein the method performed further comprises:
transmitting the content ranking score to a presenter device when the presenter device accesses the media item via the database.

5) The social media content ranking system of claim 3, wherein the method performed further comprises:
receiving a video presentation from the presenter device;
transmitting the video presentation to the user device.

6) The social media content ranking system of claim 1, wherein at least one of the metadata tags corresponds to a view count comprising a number of views a media item has received on one or more social media platforms within a particular time period.

7) The social media content ranking system of claim 1, wherein at least one of the metadata tags corresponds to a share count comprising a number of times a media item has been shared across one or more social media platforms within a particular time period.

8) The social media content ranking system of claim 1, wherein at least one of the metadata tags corresponds to a download count comprising a number of times a media item has been downloaded from one or more social media platforms within a particular time period.

9) The social media content ranking system of claim 1, wherein at least one of the metadata tags corresponds to a positive vote count comprising a number of times a media item has been awarded a positive vote from one or more social media platforms within a particular time period.

10) A social media content ranking method comprising:
receiving, at a database, a media item from a content creator device via a wireless network;
assigning one or more metadata tags to the media item, wherein each metadata tag includes a descriptor and a number value;
generating a content ranking score based on the metadata tag number values;
transmitting the content ranking score to a user device when the user device accesses the media item via wireless communication with the database via a wireless network.

11) The social media content ranking method of claim 10, wherein the media item comprises an audio recording, a video recording, or an audio and video recording.

12) The social media content ranking system of claim 10, wherein the method performed further comprises:
transmitting the content ranking score to a presenter device when the presenter device accesses the media item via the database, the presenter device having at least a display screen, a video and audio recording mechanism, an input control, and a wireless transceiver.

13) The social media content ranking method of claim 12, wherein the method performed further comprises:
receiving, at the database, a video presentation from the presenter device;
transmitting the video presentation from the database to the user device via the wireless network.

14) The social media content ranking system of claim 10, wherein at least one of the metadata tags corresponds to a view count comprising a number of views a media item has received on one or more social media platforms within a particular time period.

15) The social media content ranking system of claim 10, wherein at least one of the metadata tags corresponds to a share count comprising a number of times a media item has been shared across one or more social media platforms within a particular time period.

16) The social media content ranking system of claim 10, wherein at least one of the metadata tags corresponds to a download count comprising a number of times a media item has been downloaded from one or more social media platforms within a particular time period.

17) The social media content ranking system of claim 10, wherein at least one of the metadata tags corresponds to a positive vote count comprising a number of times a media item has been awarded a positive vote from one or more social media platforms within a particular time period.
